(19) United States
(12) Patent Application Publication
(10) Pub. No.: US 2026/0027521 A1
(43) Pub. Date: Jan. 29, 2026

(54) MICROFILTRATION CONTAINER

(71) Applicant: RATTIINOX S.R.L., Mariano Comense (Como) (IT)

(72) Inventors: Walter RATTI, Mariano Comense (Como) (IT); Raffaele SCHIAVELLA, Mariano Comense (Como) (IT)

(21) Appl. No.: 18/998,012

(22) PCT Filed: Jul. 21, 2023
(86) PCT No.: PCT/IB2023/057455

§ 371 Date: Jan. 23, 2025

(30) Foreign Application Priority Data
Aug. 1, 2022 (IT) 102022000016296

(51) Int. Cl. B01D 61/18; B01D 46/00; B01D 46/42; B01D 46/54; B01D 61/14; B01D 63/06

(52) U.S. Cl. CPC B01D 61/18; B01D 46/0005; B01D 46/001; B01D 46/4272; B01D 46/543; B01D 61/147; B01D 63/06; B01D 2265/029; B01D 2313/12; B01D 2313/18; B01D 2313/201; B01D 2313/205; B01D 2313/44; B01D 2313/60

(57) ABSTRACT

The present invention relates to a microfiltration container (2), comprising a base (1) for a microfiltration container (2), said container being adapted to contain at least one microfilter (3) and create fluid passages which force a fluid, passing from a fluid inlet (4) to a fluid outlet (5), to pass through said microfilter (3);
wherein said base (1) is a monolithic body, i.e., made in a single piece;
wherein a microfilter seat (6) is obtained in said base (1) for accommodating and securing said at least one microfilter (3);
wherein at least a first valve half-chamber (7) is obtained in said base (1), adapted to accommodate a first movable valve element (8) adapted to move from a valve opening position to a valve closing position;
wherein said at least a first valve half-chamber (7) comprises at least a first abutment surface (9) for sealing said movable valve element (8);
wherein said microfiltration container (2) comprises a container bell (28);
wherein said container bell (28) comprises a cylindrical bell body (42) in which a first lower end thereof is sealingly connectable to said base (1) and in which an upper opposite end thereof is closed by a bell cap (43).

### TECHNICAL FIELD OF THE INVENTION

The present invention generally belongs to the field of microfiltration container bases, and relates to a microfiltration container comprising said base.

In particular, the present invention relates to a microfiltration container, mainly in the field of pharmaceutical applications, biotechnologies, microelectronics and applications requiring a filtration purification technology suitable and validated to obtain sterile, non-pyrogenic fluids with high purity.

### BACKGROUND ART

In pharmaceutical applications, as in many other production fields, the filtration, both sterilizing and for producing ultra-clean fluids, is now a widespread practice.

The first applications date back to the end of the last world war with the introduction of microporous membrane filters available with different retention levels. The membrane filter (hereinafter also simply “filter”) appears in sheets and these are marketed in the form of discs or cartridges capable of covering applications that need only a few cm2 (in the form of discs) to several m2 (e.g., with cartridges with pleated membranes).

In order to be used, the filter needs to be installed in a filter-holder (hereinafter referred to as a “container”). Containers suited for both sheet filters and filtering cartridges are available.

The prior-art container for cartridges (see FIG. 1), consists of a cartridge-holder “base” and a closing “bell” adapted to contain the microfiltration cartridge. An attachment is present in the base for coupling the microfiltering cartridge, as well as two pipes with curve(s), one for introducing the solution to be filtered, while the other curve is connected to the center of the filter-holder attachment and allows taking the fluid exiting from the inner central part of the filter.

A solution of this type is described, for example, in GB2202164A and EP0051373.

In order to use these known microfiltering containers, the container needs to be equipped with a series of accessories and instruments so that the filtering barrier can produce and so that the microfiltration can be controlled and validated to achieve the object set by the process.

The use concerns both the filtration of liquid solutions (using hydrophilic filters) and the filtration of gases (using hydrophobic filters). There is a wide variety of containers and filters, which allows covering the most varied applications.

The container with accessories and instruments is the subject of a project the success of which depends on the attitude of the designers and finally on the installers. In particular, the choice of accessories and assembly modes are key aspects for the success of the project.

In particular, in order to fulfil the functions required by the process, the container with the filtering cartridge thereof should be provided with a series of accessories selected in the design stage, which allow the correct use thereof.

For example, at the inlet of the container, it can be necessary to connect:
a shut-off valve on the inlet curve;
a temperature sensor which reaches the interior of the filter;
an upstream or inlet side drain valve, to allow the emptying, the drainage of steam during sterilization, the introduction of water for verifying the integrity of the hydrophobic filter.

For example, on the container closing bell it can be necessary to connect:
a pressure sensor;
an instrument adapted to verify the integrity of the hydrophobic filter;
a valve for bleeding any air conveyed in the liquid;
a shut-off valve of the connection towards the collection of condensates if the steam has to come out from the top of the bell during sterilization;

For example, at the outlet of the container, it can be necessary to connect:
a shut-off valve on the outlet curve;
a temperature sensor for reaching the interior of the filter;
the option of sterilely sampling the filtrate immediately at the outlet of the filter and before the shut-off valve.

All these accessories are found on the market, and often unsuitable components for the application of the aseptic processing required in the pharmaceutical process or in microelectronics for high purity processes are connected.

These accessories can bring into the process:
unused portions;
asymptotic closures which are difficult to clean with the automatic “Cleaning in Place” washing technologies;
valve drives in direct contact with the fluid to be purified;
request for space about the container increasing the dead volume thereof in which the often very expensive product is kept;
undesired pollution due to the introduction of measurement probes;
pollution due to sample collection.

Therefore, in the field of pharmaceutical applications, biotechnologies and applications requiring a filtration purification technology suitable and validated to obtain sterile, non-pyrogenic fluids with high purity, especially in the presence of highly costly products, the need is strongly felt for the filtering container to be completely emptied at the end of the process.

In high technological content industries, a filtration container with features adapted to be used in such applications and provided with specifically studied and manufactured components allowing the process control thereof is not available.

In general, the known containers are equipped with components designed and manufactured for other applications and re-machined with specific connections, seals, electropolishing, controlled and certified roughness, etc., to be compliant with US Medical and Pharmaceutical standards, such as FDA, USP, 3A, BPE 2000, and EU, Japanese and Russian standards.

For industries working in the above fields, it is a key prerogative to keep, downstream of the filters, the same effluent fluid quality achieved with filtration up to the point of use, which is generally represented by the container in which it will be collected to be placed on the market.

Thus, the need is strongly felt to suggest a filter-holder container and in particular a base for this container, which is:
compact;
allows completely emptying the container when required without having residue stagnation zones;
easy to produce;
and allows aseptic processing in the pharmaceutical field or in the high purity process.

### OBJECT AND SUMMARY OF THE INVENTION

Therefore, it is the object of the present invention to overcome the drawbacks of the prior art and allow the abovementioned needs to be met, by suggesting a microfilter-holder container base capable of ensuring the fulfillment of the aforesaid needs.

These and other objects are achieved by a microfiltration container as claimed in claim 1.

Some advantageous embodiments are the subject of the dependent claims.

By virtue of the general embodiment and variants described above and further described below, it is possible to obtain the following advantages.

The suggested base and the suggested microfiltration container allow using process control devices integrated with the base and the container, forming a compact and aseptic assembly, where the geometries, which make it aseptic are largely made in one piece, i.e., in a single piece, with the base.

The suggested solution allows having a container for filters, in the structure of which (mainly the filter-holder base and subordinately the closing bell) all the available accessories designed to fulfill the application for which they are intended and which serve to make the system functional are integrated into the body thereof.

In the suggested solution, the user will find an available filtration system provided with accessories.

This solution offers several advantages:
smaller space than the solutions known to-date;
performance quality devoid of stagnation points;
use of specific components without unused portions and asymptotic closures;
dedicated access ports for pressure and temperature probes;
specific access ports for sample collection probes;
all the control valves integrated into the base body;
subordinately all the drain and ventilation valves and connection instruments on the bell;
cleaning, decontamination along with container and filter;
sterilization along with container and filter with in situ sensors.

In particular, the base of the container offers the possibility to receive all marketed types of cartridge and has a geometry which avoids product residue upstream of the cartridge at the end of filtration.

### DESCRIPTION OF THE DRAWINGS

Further features and advantages of the invention will become apparent from the description provided below of preferred embodiments thereof, given by way of non-limiting indication, with reference to the accompanying drawings, in which:

FIG. 1 shows a sectional side view according to a plane passing through a vertical and horizontal direction of a microfiltration container according to the prior art;

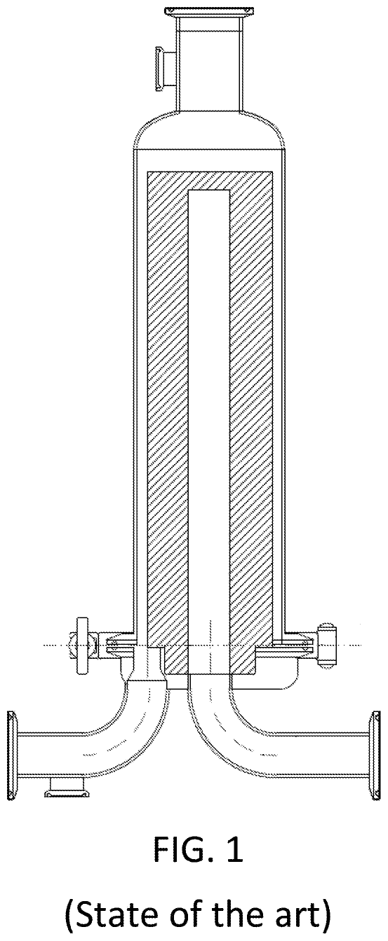

FIG. 2 shows an axonometric view of a microfiltration container according to the present invention, where the fluid inlet pipe section is placed on the left and the fluid outlet pipe section is placed on the right, the shut-off valve of the downstream drain pipe section, thus downstream of the microfilter, is placed at the front and the shut-off valve of the upstream pipe, thus upstream of the microfilter, is placed at the back;

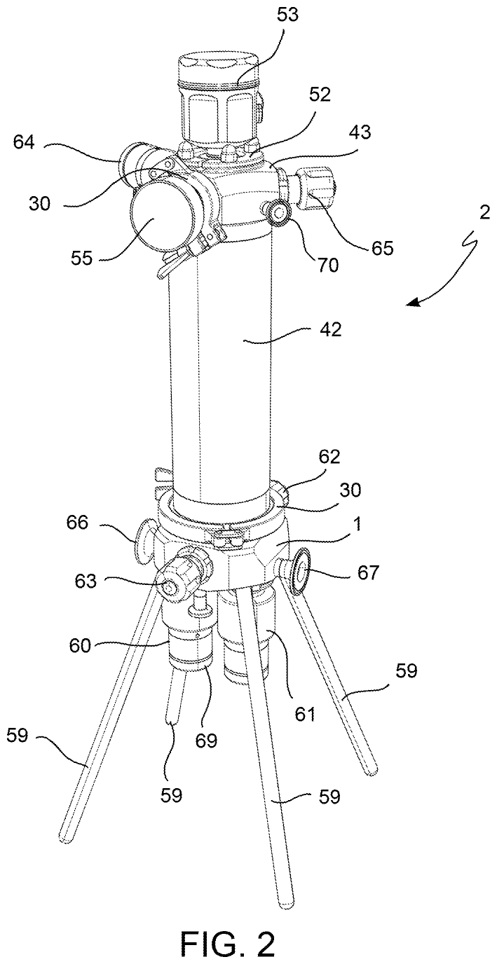

FIG. 3 shows an axonometric view of a microfiltration container in FIG. 2, where the fluid inlet pipe section is placed on the right and the fluid outlet pipe section is placed on the left, the shut-off valve of the downstream drain pipe section, thus downstream of the microfilter, is placed at the back and the shut-off valve of the upstream pipe, thus upstream of the microfilter, is placed at the front;

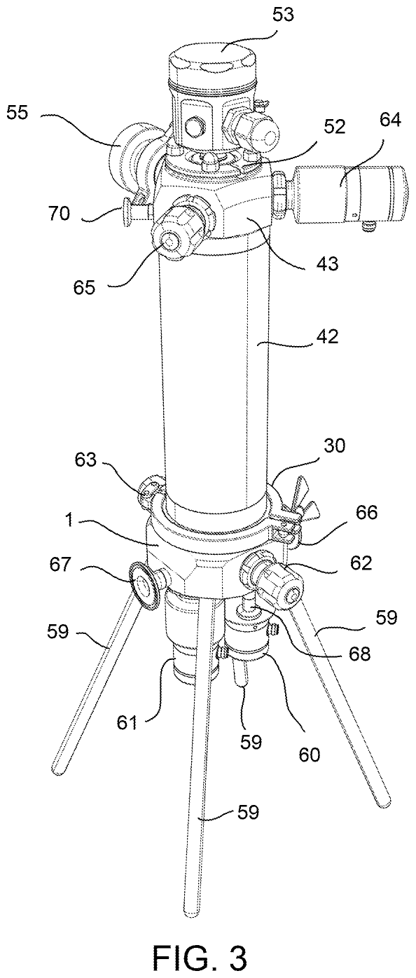

FIG. 4 shows an axonometric view of the microfiltration container in FIG. 2, sectioned according to a vertical direction and a horizontal direction passing through the axis of the fluid inlet pipe section and the fluid outlet pipe section;

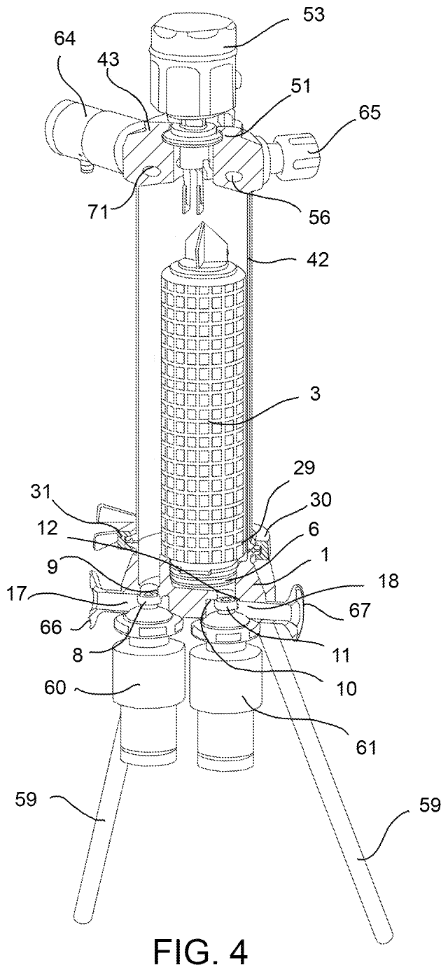

FIG. 5 shows an axonometric view of the microfiltration container in FIG. 2, sectioned according to a vertical direction and a horizontal direction passing through the axis of the shut-off valves of the downstream drain pipes on the left and of the upstream drain pipes on the right;

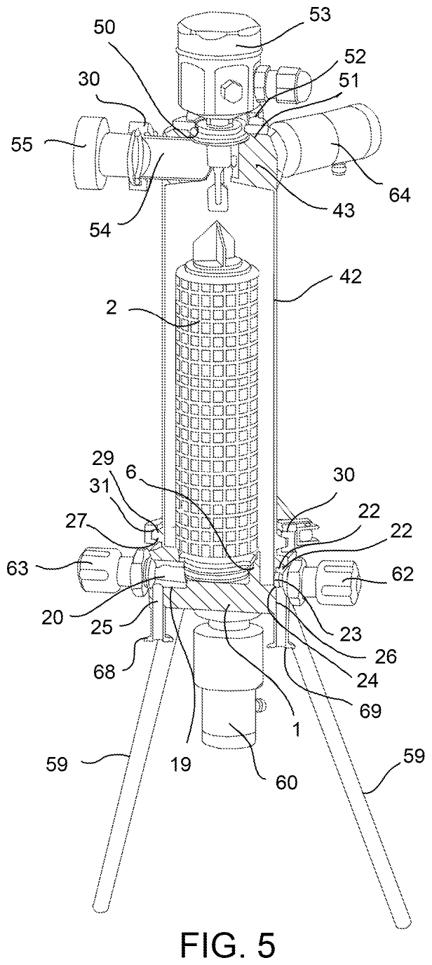

FIG. 6 shows an axonometric view of the microfiltration container in FIG. 2 in the position shown in FIG. 5, with separate parts where the bell and the integral cap are raised to show the microfilter;

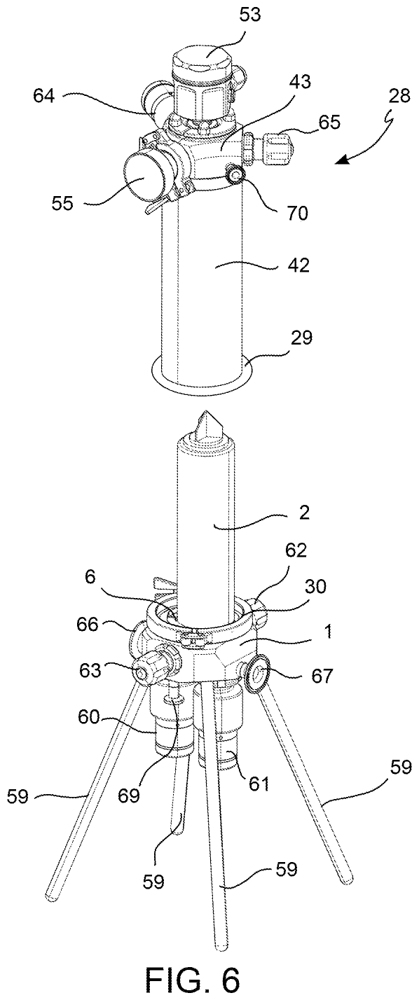

FIG. 7 shows a front view of the microfiltration container in FIG. 2, with separate parts, namely the bell, the microfilter, the screw tightening clamp, shut-off valves of the downstream drain pipes on the left and upstream drain pipes on the right, the base, the movable valve element, the second outlet shut-off valve, container support legs;

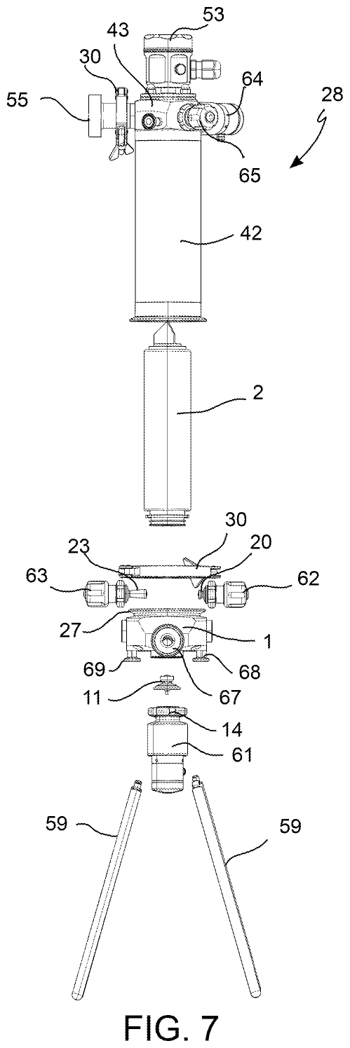

FIG. 8 shows a view opposing the view in FIG. 7 of the microfiltration container in FIG. 2, with separate parts, namely the bell, the microfilter, the screw tightening clamp, sections of outlet pipes on the left and inlet pipes on the right obtained in the base, movable valve elements on the left for shutting-off the outlet pipe and on the right for shutting-off the inlet pipe, a second outlet shut-off valve on the left and a first inlet shut-off valve on the right, container support legs;

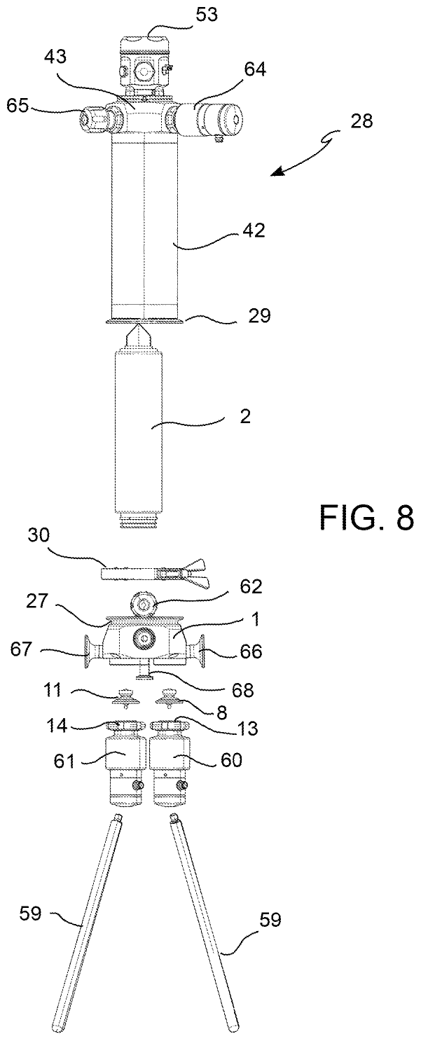

FIG. 9 shows an axonometric view of the microfiltration container in FIG. 2, with separate parts of the upper bell part provided with the cap, namely in the clockwise direction, the manometer at the front, the ventilation pipe shut-off valve, the filter integration evaluation or integrity test pipe shut-off valve, and the level sensor at the top;

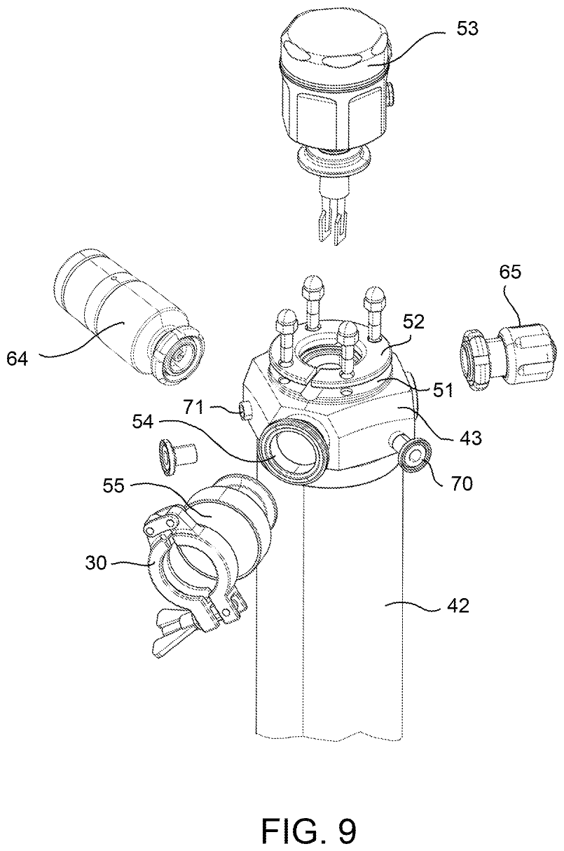

FIG. 10 shows an axonometric view of the microfiltration container in FIG. 2, with separate parts of the lower part of the microfiltration container with, starting from the bottom, the four support legs, the first inlet shut-off valve on the left and the second outlet shut-off valve on the right, movable valve elements, on the right for shutting-off the outlet pipe and on the left for shutting-off the inlet pipe, the base, the shut-off valves of the downstream drain pipe on the left and of the upstream drain pipe on the right, the screw tightening clamp, the lower part with code connection 7 or bayonet coupling of the microfilter;

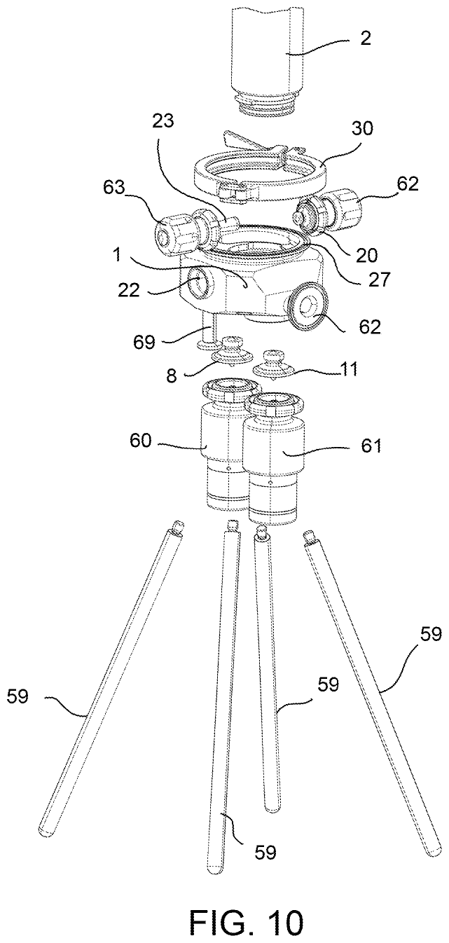

FIG. 11 shows an axonometric top view of the base in a single piece, to which there are connected the inlet pipe flange on the left and the outlet pipe flange on the right and the flange of the downstream drain pipe frontally downwards;

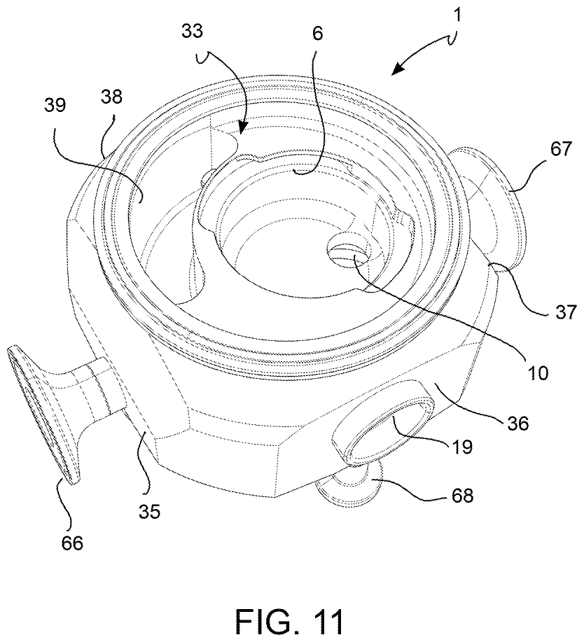

FIG. 12 shows an axonometric bottom view of the base shown in FIG. 11;

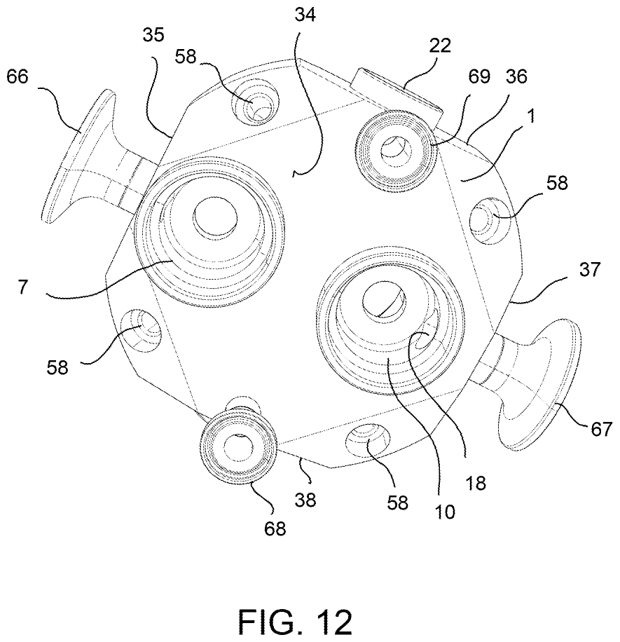

FIG. 13 shows an axonometric bottom view of the base shown in FIG. 12, in which the connection flanges of the inlet and outlet pipes have been removed;

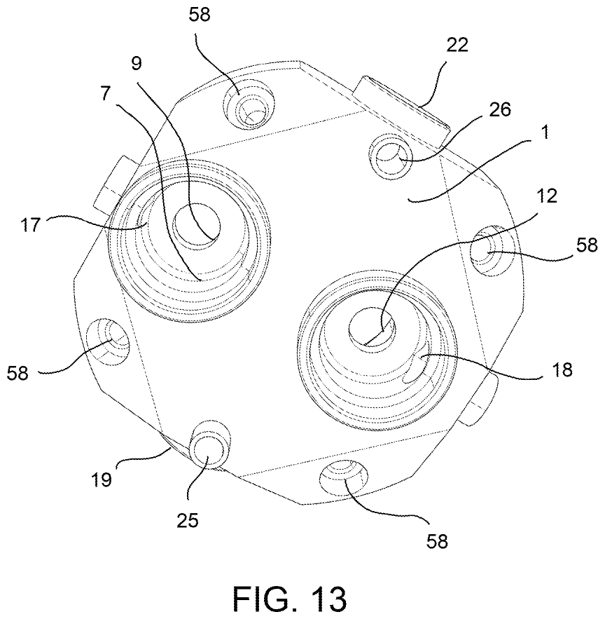

FIG. 14 shows an axonometric top view of the base in FIG. 13;

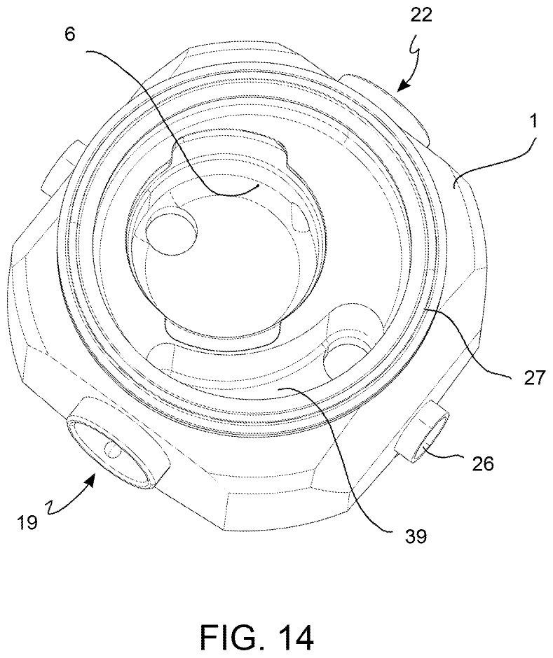

FIG. 15 shows an axonometric bottom view of the base shown in FIG. 13 rotated by 90 degrees about the vertical axis thereof in normal use;

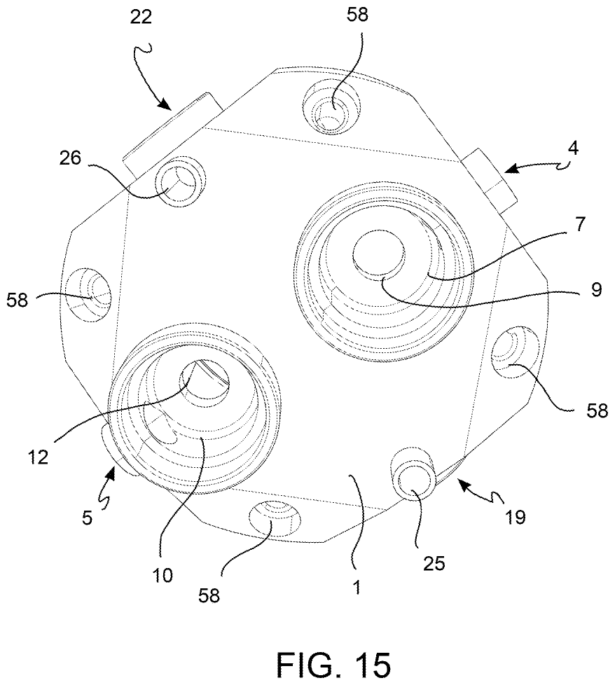

FIG. 16 shows the base in FIG. 12, sectioned according to a plane passing through the vertical axis when in normal use (shown here almost horizontal) and the axis of the shut-off valves of the upstream and downstream drain pipes;

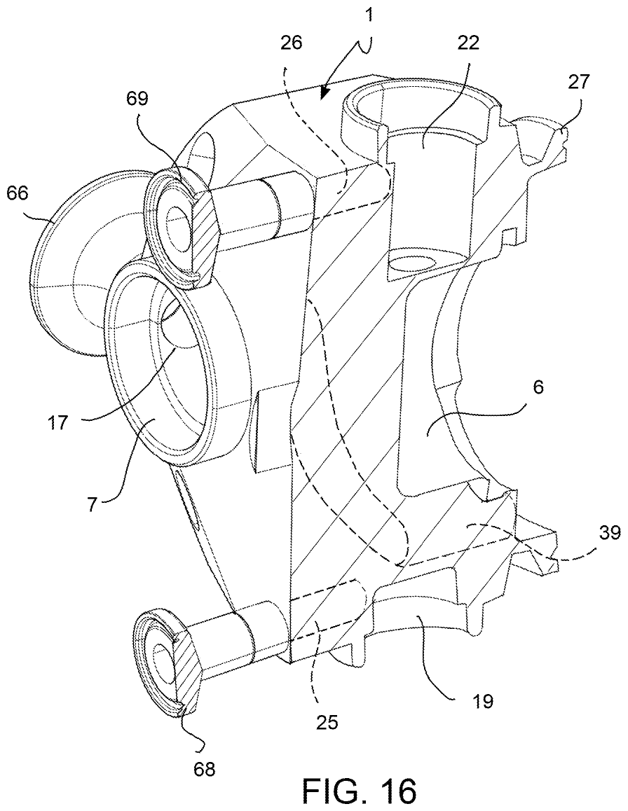

FIG. 17 shows the base in FIG. 12, sectioned according to a plane passing through the vertical axis when in normal use (shown here almost vertical) and the axis of the shut-off valves of the inlet and outlet pipes;

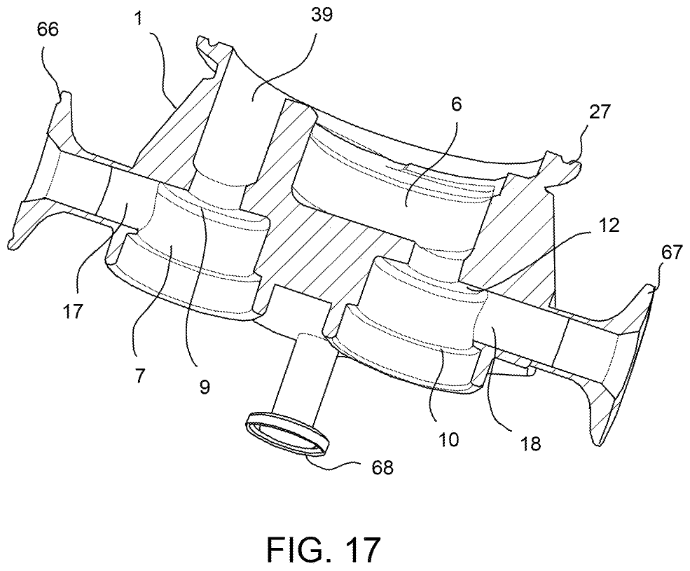

FIG. 18 shows an axonometric sectioned view of the base in FIG. 17 mounted in the microfiltration container and in which the shut-off valves of the inlet pipes on the left and of the outlet pipes on the right are in the closed position and the cartridge microfilter is connected in the microfilter seat thereof to a code seat 7 with bayonet coupling;

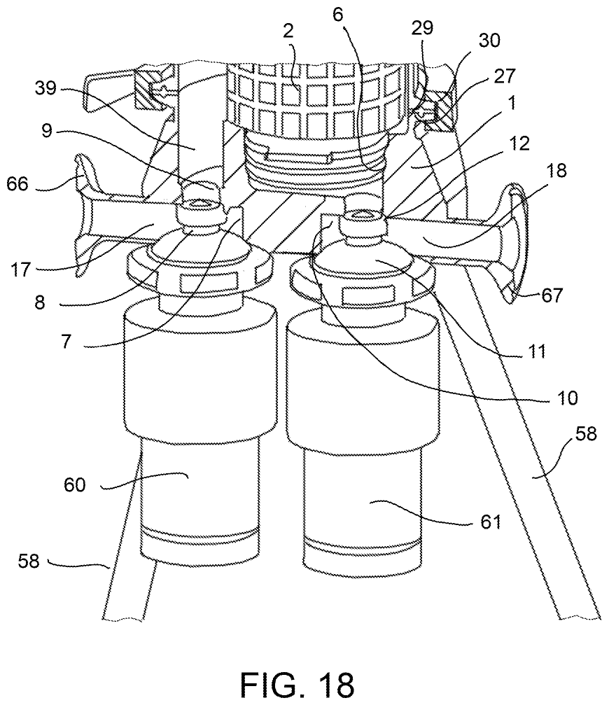

FIG. 19 shows an axonometric sectioned view of the base in FIG. 16 mounted in the microfiltration container and in which the shut-off valves of the downstream drain pipes on the left and of the upstream drain pipes on the right are in the closed position and the cartridge microfilter is connected in the microfilter seat thereof to a code seat 7 with bayonet coupling;

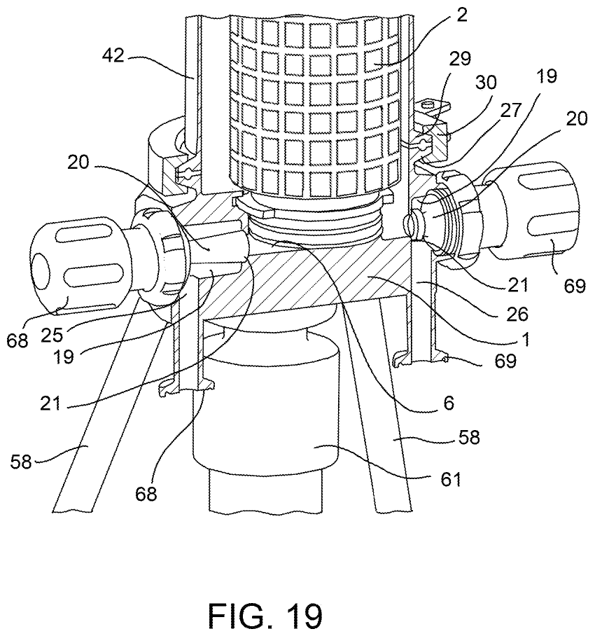

FIG. 20 shows an axonometric view of the microfiltration container, in detail the bell provided with the cap associated with the manometer, placed at the front in the figure, the ventilation pipe shut-off valve on the left, the level measurement sensor at the top, and the integrity test pipe shut-off valve on the right;

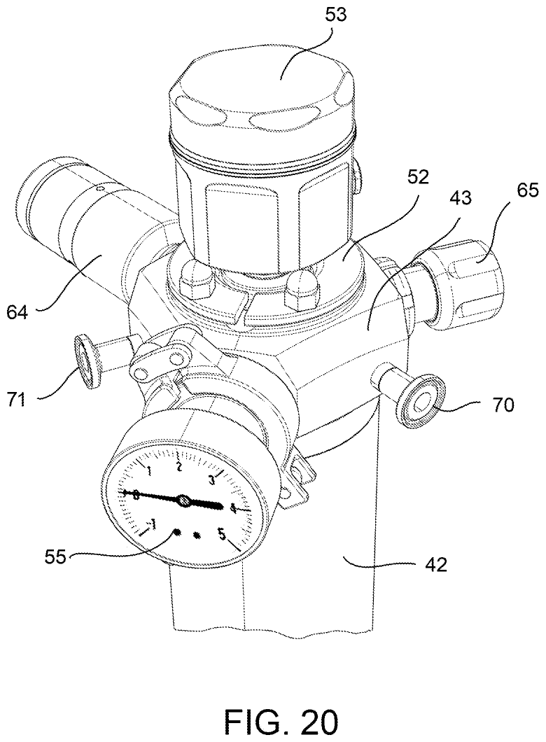

FIG. 21 shows an axonometric view of a transverse section with respect to the vertical axis of the microfiltration container at the axes of ventilation pipe shut-off valve on the right, integrity test pipe shut-off valve on the left, and manometer pipe at the top, in which part of the level sensor is sectioned in the middle;

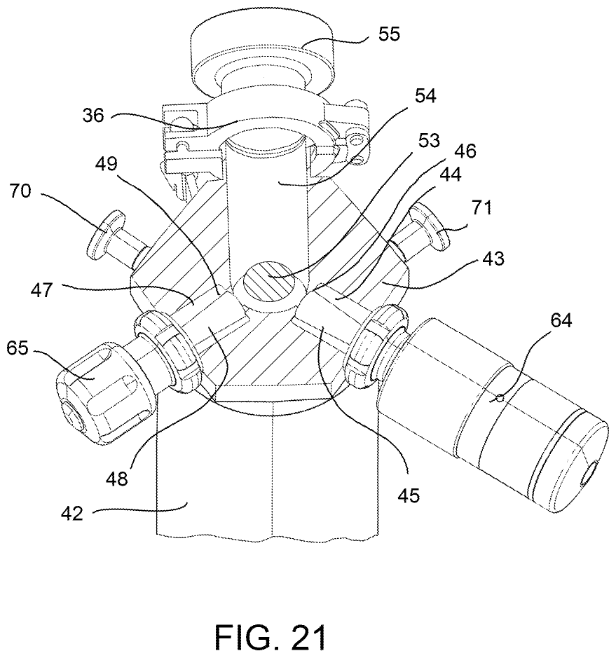

FIG. 22 shows an axonometric view of the cap alone;

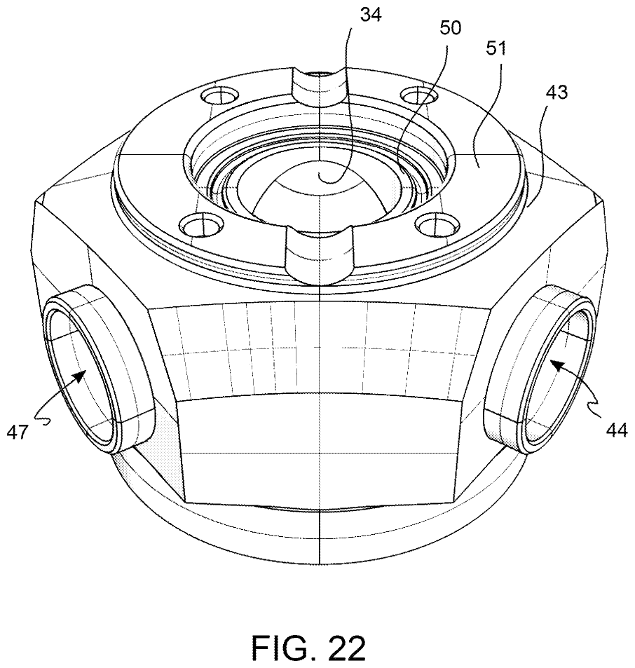

FIG. 23 shows an axonometric view of a microfiltration container, where the base is made according to the present invention and the bell is provided with the cap thereof and a single upper connection, according to the prior art.

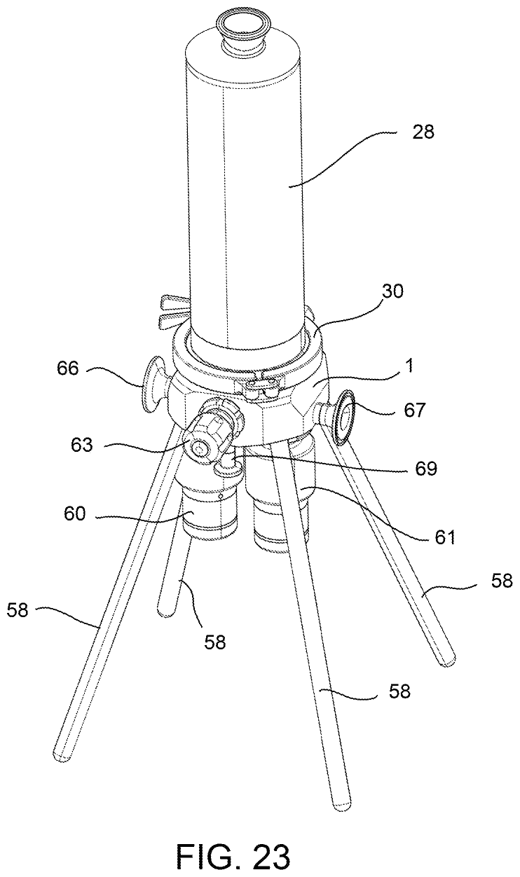

### DETAILED DESCRIPTION OF SOME PREFERRED EMBODIMENTS OF THE INVENTION

The present invention will now be described in detail with reference to the accompanying drawings to allow those skilled in the art to make and use it. Various changes to the embodiments described will be readily apparent to those skilled in the art and the general principles described can be applied to other embodiments and applications without departing from the scope of protection of the present invention, as defined in the appended claims. Therefore, the present invention should not be considered as limited to the embodiments described and shown, but should be granted the broadest scope of protection in compliance with the features described and claimed.

Unless otherwise defined, all the technical and scientific terms used herein have the same meaning commonly used by those of ordinary skill in the field to which the present invention pertains. In case of a conflict, the present description, including the definitions provided, will be binding. Moreover, the examples are merely provided for illustrative purposes, and as such they should not be considered as limiting.

In order to facilitate the understanding of the embodiments described herein, reference will be made to some specific embodiments and a specific language will be used to describe them. The terminology used herein has the purpose of describing only particular embodiments, and is not intended to limit the scope of the present invention.

According to a general embodiment, a base for a microfiltration container 2 is indicated in the figures by reference numeral 1.

Said microfiltration container 2, or container, is adapted to contain at least one microfilter 3, e.g., a cylindrical cartridge with outer peripheral inlet and central outlet, and create fluid passages which force a fluid, passing from a fluid inlet 4 to a fluid outlet 5, to pass through said microfilter 3.

Said base 1 is a monolithic body, i.e., a body made in a single piece. For example, a metal monobloc machined by chip removal.

A microfilter seat 6 is obtained in said base 1 for accommodating and securing said at least one microfilter 3;
where at least a first valve half-chamber 7 8 is obtained in said base 1, adapted to accommodate a first movable valve element adapted to move from a valve opening position to a valve closing position.

Said at least a first valve half-chamber 7 comprises at least a first abutment surface 9 for sealing said movable valve element 8.

According to an embodiment, said first valve half-chamber 7 is a fluid inlet valve half-chamber.

According to a different embodiment, said first valve half-chamber is a fluid outlet valve half-chamber.

According to an embodiment, at least a second valve half-chamber 10 is obtained in said base 1, adapted to accommodate a second movable valve element 11 adapted to move from a valve opening position to a valve closing position.

According to an embodiment, said at least a second valve half-chamber 10 comprises at least a second abutment surface 12 for sealing said second movable valve element 11.

According to an embodiment, said second valve half-chamber 10 is a fluid outlet valve half-chamber.

According to a different embodiment, said second valve half-chamber is a fluid inlet valve half-chamber.

According to an embodiment, said first or second valve half-chamber 7 or 10 is adapted to be coupled to and sealed by a first or second valve counter-half-chamber 13 or 14 so as to form a first or a second chamber 15 or 16 of first or second valve accommodating said first or second movable valve element 8 or 11.

According to an embodiment, at least one fluid inlet or outlet pipe section 17 or 18 is obtained in said base 1.

According to an embodiment, said at least one fluid inlet or outlet pipe section 17 or 18 opens out into said first valve half-chamber 7.

According to an embodiment, at least one fluid inlet or outlet pipe section 18 or 17 is obtained in said base 1.

According to an embodiment, said at least one fluid inlet or outlet pipe section 18 or 17 opens out into said second valve half-chamber 10.

According to an embodiment, at least a third valve half-chamber 19 is obtained in said base 1, adapted to accommodate a third movable valve element 20 adapted to move from a valve opening position to a valve closing position.

According to an embodiment, said at least a third valve half-chamber 19 comprises at least a third abutment surface 21 for sealing said third movable valve element 20.

According to an embodiment, at least a third upstream drain valve half-chamber 19 is obtained in said base 1, adapted to accommodate a third movable valve element 20 adapted to move from a valve opening position to a valve closing position.

According to an embodiment, said at least a third upstream valve half-chamber 19 comprises at least a third abutment surface 21 for sealing said third movable valve element 20.

According to an embodiment, at least a fourth valve half-chamber 22 is obtained in said base 1, adapted to accommodate a fourth movable valve element 23 adapted to move from a valve opening position to a valve closing position.

According to an embodiment, said at least a fourth valve half-chamber 22 comprises at least a fourth abutment surface 24 for sealing said fourth movable valve element 20.

According to an embodiment, at least a fourth downstream valve half-chamber 22 is obtained in said base 1, adapted to accommodate a fourth movable valve element 23 adapted to move from a valve opening position to a valve closing position.

According to an embodiment, said at least a fourth downstream valve half-chamber 22 comprises at least a fourth abutment surface 24 for sealing said fourth movable valve element 20.

According to an embodiment, at least one upstream or downstream drain pipe section 25 or 26 is obtained in said base 1.

According to an embodiment, said at least one upstream or downstream drain pipe section 25 or 26 opens out into said third valve half-chamber (19).

According to an embodiment, at least one upstream or downstream drain pipe section 26 or 25 is obtained in said base 1.

According to an embodiment, said at least one upstream or downstream drain pipe section 26 or 25 opens out into said fourth valve half-chamber 22.

According to an embodiment, said base 1 comprises a base connection flange 27 for the connection with a container bell 28 to form the body of said microfiltration container 2.

According to an embodiment, said container bell 28 comprises a movable connection counter-flange 29 adapted to face said base connection flange 27.

According to an embodiment, said flange and counter-flange 27, 29 are circled by at least one screw tightening clamp 30, which accommodates said flange and counter-flange 27, 29 in an upside down “V”-shaped groove 31 thereof, e.g., a Vband—adjustable clamp of the I-bolt scaffold clamp/swivel coupler type.

According to an embodiment, said base 1 comprises a peripheral sleeve 32, an upper container bottom surface 33, an outer lower surface 34.

According to an embodiment, said peripheral sleeve 32 comprises four levelings 35, 36, 37, 38 opposed two by two.

According to an embodiment, a fluid inlet pipe section 17 and a fluid outlet pipe section 18 are provided in two opposing levelings 35, 37.

According to an embodiment, a third valve half-chamber 19 and a fourth valve half-chamber 22 open out into two opposing levelings 36, 38.

According to an embodiment, a first valve half-chamber 7 and a second valve half-chamber 10 open out into said upper container bottom surface 33.

According to an embodiment, the microfilter seat 6 opens out into said upper container bottom surface 33 and is fluidly connected to said second valve half-chamber 10.

According to an embodiment, said upstream drain pipe section 25 and said downstream drain pipe section 26 open out into said outer lower surface 34.

According to an embodiment, said upstream drain pipe section 25 is fluidly connected to said third valve half-chamber 19.

According to an embodiment, said downstream drain pipe section 26 is fluidly connected to said fourth valve half-chamber 22.

According to an embodiment, said base 1 comprises a peripheral channel 39, which fluidly connects said third valve half-chamber 19 and said first valve half-chamber 7.

According to an embodiment, each valve half-chamber 7, 10, 19, 22 is sealed by a valve counter-half-chamber 13, 14, 40, 41 connected by means of a threaded flange.

According to an embodiment, when the base 1 is in the use position, each valve half-chamber 7, 10, 19, 22 and/or each valve counter-half-chamber 13, 14, 40, 41 has aseptic geometries, i.e., capable of draining every minimum amount of fluid or, in other words, devoid of fluid stagnation zones.

According to an embodiment, when the base 1 is in the use position, each pipe section 17, 18, 25, 26 has aseptic geometries, i.e., capable of draining every minimum amount of fluid or, in other words, devoid of fluid stagnation zones.

The present invention also relates to a microfiltration container 2 comprising a base 1 according to any one of the above-described embodiments.

According to an embodiment, said microfiltration container 2 comprises a container bell 28.

According to an embodiment, said container bell 28 comprises a cylindrical bell body 42 in which a first lower end thereof is sealingly connectable to said base 1 and in which an upper opposite end thereof is closed by a bell cap 43.

According to an embodiment, said cylindrical bell body 42 and bell cap 43 are firmly connected to form a single piece.

According to an embodiment, said bell cap 43 is a monolithic body, i.e., made in a single piece.

According to an embodiment, at least a fifth valve half-chamber 44 is obtained in said bell cap 43, adapted to accommodate a fifth movable valve element 45 adapted to move from a valve opening position to a valve closing position.

According to an embodiment, said at least a fifth valve half-chamber 43 comprises at least a fifth abutment surface 46 for sealing said fifth movable valve element 45.

According to an embodiment, at least a sixth valve half-chamber 47 is obtained in said bell cap 43, adapted to accommodate a sixth movable valve element 48 adapted to move from a valve opening position to a valve closing position.

According to an embodiment, said at least a sixth valve half-chamber 47 comprises at least a sixth abutment surface 49 for sealing said sixth movable valve element 48.

According to an embodiment, at least one level sensor chamber 50 is obtained in said bell cap 43, comprising a level sensor connection flange 51 for the connection with a clamp connection adapter unit 52, i.e., a Zero Dead Leg connection flange, or ZDL connection, and is adapted to connect a level sensor 53.

According to an embodiment, at least one manometer connection pipe 54 is obtained in said bell cap 43 for the connection of a manometer 55.

According to an embodiment, at least one integrity test pipe section 56 is obtained in said bell cap 43.

According to an embodiment, said at least one integrity test pipe section 56 is fluidly connected to said sixth valve half-chamber 47.

According to an embodiment, when said base 1 is connected to said container bell 28, it delimits an inner microfilter chamber 57 which accommodates at least one microfilter 3 which separates said fluid inlet pipe section 17 from said fluid outlet pipe section 18.

According to an embodiment, said base 1 comprises at least one blind seat 58 for the connection of a container support leg 59.

In order to meet specific, contingent needs, those skilled in the art may make several changes and adaptations to the above-described embodiments and replace elements with others which are functionally equivalent, without however departing from the scope of the following claims.

According to an embodiment, when the base is not mounted, the microfilter seat 6 is obtained in the base 1 facing outwards from the opposite side with respect to how the first abutment surface 9 faces outwards.

According to an embodiment, when the base is not mounted, the microfilter seat 6 is obtained in the base 1 facing outwards towards different directions with respect to how the first abutment surface 9 faces outwards.

According to an embodiment, the first movable valve element 8 is accommodated in the first valve half-chamber 7 so as to move along a first movable valve element translation path to abut on the first abutment surface 9.

According to an embodiment, the microfilter seat 6 differs from the first abutment surface 9.

### REFERENCE NUMERALS

1 base
2 microfiltration container
3 microfilter
4 fluid inlet
5 fluid outlet
6 microfilter seat, e.g., a code seat 7—bayonet coupling
7 first inlet or valve half-chamber
8 first movable valve element
9 first abutment surface
10 second outlet or valve half-chamber
11 second movable valve element
12 second abutment surface
13 first valve counter-half-chamber
14 second valve counter-half-chamber
15 first chamber of first valve
16 second chamber of second valve
17 fluid inlet pipe section
18 fluid outlet pipe section
19 third upstream drain or valve half-chamber
20 third movable valve element
21 third abutment surface
22 fourth downstream drain or valve half-chamber
23 fourth movable valve element
24 fourth abutment surface
25 upstream drain pipe section
26 downstream drain pipe section
27 base connection flange
28 container bell
29 movable bell connection counter-flange
30 screw tightening clamp
31 upside down “V”-shaped groove
32 peripheral sleeve
33 upper container bottom surface
34 outer lower surface
35 sleeve leveling
36 sleeve leveling
37 sleeve leveling
38 sleeve leveling
39 peripheral channel
40 third valve counter-half-chamber
41 fourth valve counter-half-chamber
42 cylindrical bell body
43 bell cap
44 fifth ventilation or valve half-chamber
45 fifth movable valve element
46 fifth abutment surface
47 sixth integrity test or valve half-chamber
48 sixth movable valve element
49 sixth abutment surface
50 level sensor chamber
51 level sensor connection flange
52 clamp connection adapter unit
53 level sensor
54 manometer connection pipe
55 manometer
56 integrity test pipe section
57 inner microfilter chamber
58 blind seat
59 container support leg
60 inlet valve
61 outlet valve
62 upstream drain valve
63 downstream drain valve
64 ventilation valve
65 integrity test valve
66 inlet connection
67 outlet connection
68 upstream drain connection
69 downstream drain connection
70 integrity test pipe connection
71 ventilation pipe section

1-24. (canceled)

25. A microfiltration container comprising a base for a microfiltration container, said container being adapted to contain at least one microfilter and create fluid passages which force a fluid, passing from a fluid inlet to a fluid outlet, to pass through said microfilter;
wherein said base is a monolithic body, i.e., made in a single piece;
wherein a microfilter seat is obtained in said base for accommodating and securing said at least one microfilter;
wherein at least a first valve half-chamber is obtained in said base, adapted to accommodate a first movable valve element adapted to move from a valve opening position to a valve closing position;
wherein said at least a first valve half-chamber comprises at least a first abutment surface for sealing said movable valve element;
wherein said microfiltration container comprises a container bell;
wherein said container bell comprises a cylindrical bell body in which a first lower end thereof is sealingly connectable to said base and in which an upper opposite end thereof is closed by a bell cap.

26. A microfiltration container according to claim 25, wherein said first valve half-chamber is a fluid inlet valve half-chamber;
or
wherein said first valve half-chamber is a fluid outlet valve half-chamber.

27. A microfiltration container according to claim 25, wherein at least a second valve half-chamber is obtained in said base, adapted to accommodate a second movable valve element adapted to move from a valve opening position to a valve closing position;
wherein said at least a second valve half-chamber comprises at least a second abutment surface for sealing said second movable valve element.

28. A microfiltration container according to claim 25,
wherein said second valve half-chamber is a fluid outlet valve half-chamber;
or
wherein said second valve half-chamber is a fluid inlet valve half-chamber.

29. A microfiltration container according to claim 27, wherein said first or second valve half-chamber is adapted to be coupled to and sealed by a first or second valve counter-half-chamber so as to form a first or second chamber of first or second valve accommodating said first or second movable valve element.

30. A microfiltration container according to claim 27,
wherein at least one fluid inlet or outlet pipe section is obtained in said base; and wherein said at least one fluid inlet or outlet pipe section opens out into said first valve half-chamber;
or
wherein at least one fluid outlet or inlet pipe section is obtained in said base; and wherein said at least one fluid outlet or inlet pipe section opens out into said second valve half-chamber.

31. A microfiltration container according to claim 25,
wherein at least a third valve half-chamber is obtained in said base, adapted to accommodate a third movable valve element adapted to move from a valve opening position to a valve closing position; and wherein said at least a third valve half-chamber comprises at least a third abutment surface for sealing said third movable valve element;
or
wherein at least a third upstream drain valve half-chamber is obtained in said base, adapted to accommodate a third movable valve element adapted to move from a valve opening position to a valve closing position; and wherein said at least a third upstream valve half-chamber comprises at least a third abutment surface for sealing said third movable valve element.

32. A microfiltration container according to claim 25,
wherein at least a fourth valve half-chamber is obtained in said base, adapted to accommodate a fourth movable valve element adapted to move from a valve opening position to a valve closing position; and wherein said at least a fourth valve half-chamber comprises at least a fourth abutment surface for sealing said fourth movable valve element;
or
wherein at least a fourth downstream valve half-chamber is obtained in said base, adapted to accommodate a fourth movable valve element adapted to move from a valve opening position to a valve closing position; and wherein said at least a fourth downstream valve half-chamber comprises at least a fourth abutment surface for sealing said fourth movable valve element.

33. A microfiltration container according to claim 31,
wherein at least one upstream or downstream drain pipe section is obtained in said base; and wherein said at least one upstream or downstream drain pipe section opens out into said third valve half-chamber;
or
wherein at least one downstream or upstream drain pipe section is obtained in said base; and wherein said at least one downstream or upstream drain pipe section opens out into said fourth valve half-chamber.

34. A microfiltration container according to claim 25, wherein said base comprises a base connection flange for the connection with a container bell to form the body of said microfiltration container;
wherein said container bell comprises a movable connection counter-flange adapted to face said base connection flange;
wherein said flange and counter-flange are circled by at least one screw tightening clamp, which accommodates said flange and counter-flange in an upside down “V” shaped groove thereof, e.g., a Vband—adjustable clamp of the I-bolt scaffold clamp/swivel coupler type.

35. A microfiltration container according to claim 25, wherein said base comprises a peripheral sleeve, an upper container bottom surface, an outer lower surface;
wherein said peripheral sleeve comprises four levelings opposed two by two;
wherein a fluid inlet pipe section and a fluid outlet pipe section are provided in two opposing levelings;
wherein a third valve half-chamber and a fourth valve half-chamber open out into two opposing levelings;
wherein a first valve half-chamber and a second valve half-chamber open out into said upper container bottom surface;
wherein the microfilter seat opens out into said upper container bottom surface and is fluidly connected to said second valve half-chamber.

36. A microfiltration container according to claim 33, wherein said upstream drain pipe section and said downstream drain pipe section open out into said outer lower surface;
wherein said upstream drain pipe section is fluidly connected to said third valve half-chamber;
wherein said downstream drain pipe section is fluidly connected to said fourth valve half-chamber.

37. A microfiltration container according to claim 31, wherein said base comprises a peripheral channel, which fluidly connects said third valve half-chamber and said first valve half-chamber.

38. A microfiltration container according to claim 25, wherein each valve half-chamber is sealed by a valve counter-half-chamber connected by means of a threaded flange.

39. A microfiltration container according to claim 25, wherein, when the base is in the use position, each valve half-chamber and/or each valve counter-half-chamber has aseptic geometries, i.e., capable of draining every minimum amount of fluid, i.e., devoid of fluid stagnation zones.

40. A microfiltration container according to claim 30, wherein, when the base is in the use position, each pipe section has aseptic geometries, i.e., capable of draining every minimum amount of fluid, i.e., devoid of fluid stagnation zones.

41. A microfiltration container according to claim 25, wherein said cylindrical bell body and bell cap are firmly connected to form a single piece.

42. A microfiltration container according to claim 25, wherein said bell cap is a monolithic body, i.e., made in a single piece;
wherein at least a fifth valve half-chamber is obtained in said bell cap, adapted to accommodate a fifth movable valve element adapted to move from a valve opening position to a valve closing position;
wherein said at least a fifth valve half-chamber comprises at least a fifth abutment surface for sealing said fifth movable valve element.

43. A microfiltration container according to claim 25, wherein said bell cap is a monolithic body, i.e., made in a single piece;
wherein at least a sixth valve half-chamber is obtained in said bell cap, adapted to accommodate a sixth movable valve element adapted to move from a valve opening position to a valve closing position;
wherein said at least a sixth valve half-chamber comprises at least a sixth abutment surface for sealing said sixth movable valve element.

44. A microfiltration container according to claim 25, wherein said bell cap is a monolithic body, i.e., made in a single piece;
wherein at least one level sensor chamber is obtained in said bell cap, comprising a level sensor connection flange for the connection with a clamp connection adapter unit, i.e., a Zero Dead Leg connection flange, or ZDL connection, and adapted to connect a level sensor.

45. A microfiltration container according to claim 25, wherein said bell cap is a monolithic body, i.e., made in a single piece;
wherein at least one manometer connection pipe is obtained in said bell cap for the connection of a manometer.

46. A microfiltration container according to claim 25, wherein said bell cap is a monolithic body, i.e., made in a single piece;
wherein at least one integrity test pipe section is obtained in said bell cap;
wherein said at least one integrity test pipe section is fluidly connected to said sixth valve half-chamber.

47. A microfiltration container according to claim 25, wherein, when said base is connected to said container bell, it delimits an inner microfilter chamber which accommodates at least one microfilter which separates said fluid inlet pipe section from said fluid outlet pipe section.

48. A microfiltration container according to claim 25, wherein said base comprises at least one blind seat for the connection of a container support leg.

49. A microfiltration container according to claim 25, wherein, when the base is not mounted, the microfilter seat is disposed in the base facing outwards from the opposite side with respect to how the first abutment surface faces outwards.

50. A microfiltration container according to claim 25, wherein, when the base is not mounted, the microfilter seat is disposed in the base facing outwards towards different directions with respect to how the first abutment surface faces outwards.

51. A microfiltration container according to claim 25, wherein the first movable valve element is accommodated in the first valve half-chamber so as to move along a first movable valve element translation path to abut on the first abutment surface.

52. A microfiltration container according to claim 25, wherein, the microfilter seat differs from the first abutment surface.
